(19) United States
(12) Patent Application Publication
(10) Pub. No.: US 2016/0169451 A1
(43) Pub. Date: Jun. 16, 2016

(54) PROCESS AND SYSTEM FOR DELIVERING STEAM

(71) Applicant: FCCL PARTNERSHIP, Calgary (CA)

(72) Inventors: Joseph Patrick Sauve, Calgary (CA); Dale Warren Greene, Calgary (CA); Mark A. Bilozir, Calgary (CA); Darren Jones, Calgary (CA); Michael J. Smith, Calgary (AB)

(21) Appl. No.: 14/965,808

(22) Filed: Dec. 10, 2015

Related U.S. Application Data
(60) Provisional application No. 62/090,936, filed on Dec. 12, 2014.

(51) Int. Cl. F17D 1/18; F17D 1/06

(52) U.S. Cl. CPC F17D 1/18; F17D 1/06

(57) ABSTRACT

A system, process and apparatus for delivering steam to a wellhead associated with a steam-assisted hydrocarbon recovery operation is disclosed. The process involves receiving a steam flow having a first steam quality at an inlet of a steam conduit, the inlet being located at a remote location with respect to the wellhead. The process also involves transporting the steam flow along the steam conduit to an outlet at the wellhead, the steam flow being subject to losses during transport along the steam conduit causing formation of condensate within the steam flow thereby reducing the steam quality at the outlet. The process further involves delivering a heat flux through a wall of the steam conduit, the heat flux being sufficient to cause at least a portion of the condensate to be vaporized before reaching the outlet of the steam conduit thereby increasing the steam quality to a second steam quality for delivery to the wellhead.

### BACKGROUND OF THE INVENTION

1. Field of Invention

This invention relates generally to steam-assisted hydrocarbon recovery operations and more particularly to delivering steam to a wellhead for such operations.

2. Description of Related Art

In hydrocarbon recovery operations steam is used for extracting heavy oil through cyclic steam stimulation, steam flooding, or steam-assisted gravity drainage (SAGD), for example. The cost of steam generation and the associated generation of emissions is a major consideration in assessing economic potential of hydrocarbon recovery operations.

### SUMMARY OF THE INVENTION

In accordance with one disclosed aspect there is provided a process for delivering steam to a wellhead associated with a steam-assisted hydrocarbon recovery operation. The process involves receiving a steam flow having a first steam quality at an inlet of a steam conduit, the inlet being located at a remote location with respect to the wellhead. The process also involves transporting the steam flow along the steam conduit to an outlet at the wellhead, the steam flow being subject to losses during transport along the steam conduit causing formation of condensate within the steam flow thereby reducing the steam quality at the outlet. The process further involves delivering a heat flux through a wall of the steam conduit, the heat flux being sufficient to cause at least a portion of the condensate to be vaporized before reaching the outlet of the steam conduit thereby increasing the steam quality to a second steam quality for delivery to the wellhead.

Delivering the heat flux may involve delivering a heat flux along a portion of the steam conduit proximate the wellhead.

The inlet of the steam conduit and the outlet of the steam conduit may be spaced apart by more than about 1000 meters and delivering the heat flux along the portion of the steam conduit may involve delivering a heat flux along a portion of the steam conduit extending between the outlet at the wellhead and a location between about 50 meters and about 300 meters along the steam conduit from the wellhead.

Delivering the heat flux may involve delivering a sufficiently uniform heat flux to reduce temperature gradients within the wall of the steam conduit below a temperature gradient threshold.

Delivering the sufficiently uniform heat flux may involve delivering a heat flux having sufficient uniformity to prevent local temperature increases in the wall of the steam conduit exceeding a wall temperature threshold associated with safe transport of steam through the steam conduit.

Receiving the steam flow may involve generating the steam flow in a steam generator and the method may further involve selecting a steam generation target range for the first steam quality, controlling the steam generator to provide a steam flow having a steam quality within the steam generation target range, and controlling the delivery of heat flux to increase the second steam quality to within a steam delivery target range.

At least one of the steam generation target range and the steam delivery target range may be selected to optimize an overall economic efficiency associated with generation of the steam flow and the recovery of hydrocarbons in the hydrocarbon recovery operation.

The steam conduit may be operable to deliver steam to a plurality of wellheads and delivering the heat flux may involve delivering a heat flux to portions of steam conduit disposed to deliver steam to at least two of the plurality of wellheads.

Delivering the heat flux may involve generating heat at a plurality of locations disposed about a periphery of the steam conduit.

Generating heat at the plurality of locations disposed about the periphery of the steam conduit may involve generating heat at a plurality of locations spaced outwardly from the wall of the steam conduit.

Generating heat may involve generating heat to cause at least a portion of the generated heat to be coupled by thermal radiation into the wall of the steam conduit.

The process may further involve providing thermal insulation between the plurality of locations disposed about the periphery of the steam conduit and an environment surrounding the steam conduit.

The process may involve enclosing the heat generating locations and the thermal insulation within a housing.

The housing may be configured to permit installation on the steam conduit while the steam conduit is transporting a steam flow.

Delivering the heat flux may involve generating the heat flux by converting electrical energy into thermal energy at a plurality of heating elements disposed about a periphery of the steam conduit.

Delivering the heat flux may involve generating the heat flux by converting electrical energy into thermal energy at a plurality of heating elements each extending along at least a portion the steam conduit steam disposed to deliver steam to the wellhead.

The process may involve monitoring at least one parameter associated with transporting the steam flow along the steam conduit and controlling the delivery of heat flux in response to the at least one parameter.

The at least one parameter may include at least one of an electrical power level associated with delivering the heat flux, a steam flow temperature within the steam conduit, a wall temperature of the steam conduit, a plurality of wall temperatures associated with a respective plurality of locations about a periphery of the wall of the steam conduit, a density measurement associated with the steam flow, a stress within the wall of the steam conduit, and a strain in the wall of the steam conduit.

Controlling the delivery of heat flux may involve interrupting the delivery of heat flux in response to the at least one parameter exceeding a threshold level.

In accordance with another disclosed aspect there is provided a system for delivering steam to a wellhead associated with a steam-assisted hydrocarbon recovery operation. The system includes a steam generator for generating a steam flow having a first steam quality. The system also includes a steam conduit having an inlet for receiving the steam flow and an outlet proximate the wellhead. The inlet is located at a remote location with respect to the wellhead. The steam conduit is operable to transport the steam flow to the outlet, the steam flow being subject to losses during transport along the steam conduit causing formation of condensate within the steam flow thereby reducing the steam quality at the outlet. The system also includes a heater operable to deliver a heat flux through a wall of the steam conduit, the heat flux being sufficient to cause at least a portion of the condensate to be vaporized before reaching the outlet of the steam conduit thereby increasing the steam quality to a second steam quality for deliver to the wellhead.

The heater may be disposed to deliver the heat flux along a portion of the steam conduit proximate the wellhead.

The inlet of the steam conduit and the outlet of the steam conduit may be spaced apart by more than about 1000 meters and the heater may be disposed to deliver the heat flux along the portion of the steam conduit between the outlet at the wellhead and a location between about 50 meters and about 300 meters along the steam conduit from the wellhead.

The heater may be configured to deliver a sufficiently uniform heat flux to reduce temperature gradients within the wall of the steam conduit below a temperature gradient threshold.

The heater may be configured to deliver a heat flux having sufficient uniformity to prevent local temperature increases in the wall of the steam conduit exceeding a wall temperature threshold associated with safe transport of steam through the steam conduit.

The system may include a controller operable to control the steam generator to generate a steam flow having a first steam quality within a selected steam generation target range, and control the heater to deliver the heat flux to increase the second steam quality to within a steam delivery target range.

At least one of the steam generation target range and the steam delivery target range may be selected to optimize an overall economic efficiency associated with generation of the steam flow and the recovery of hydrocarbons in the hydrocarbon recovery operation.

The steam conduit may be operable to deliver steam to a plurality of wellheads and the heater may include a plurality of heaters, each heater being disposed to deliver a heat flux to a portion of the steam conduit disposed to deliver steam to each respective wellhead in the plurality of wellheads.

The heater may be configured to generate heat at a plurality of locations disposed about a periphery of the steam conduit.

The heater may be configured to generate heat at a plurality of locations spaced outwardly from the wall of the steam conduit.

The heater may include a heat radiator operable to couple the heat flux into the wall of the steam conduit by thermal radiation.

The heater may include thermal insulation for reducing heat losses to an environment surrounding the steam conduit.

The heater may include a housing enclosing the heater and the thermal insulation.

The housing may be configured to permit installation on the steam conduit while the steam conduit is transporting a steam flow.

The heater may include an electrical heater having a plurality of heating elements disposed about a periphery of the steam conduit.

The heater may include an electrical heater having a plurality of heating elements each extending along at least a portion the steam conduit steam disposed to deliver steam to the wellhead.

The system may include a controller operably configured to monitor at least one parameter associated with transport of the steam flow along the steam conduit and to control the heater for delivering the heat flux in response to the at least one parameter.

The at least one parameter may include at least one of an electrical power level associated with delivering the heat flux, a steam flow temperature within the steam conduit, a wall temperature of the steam conduit, a plurality of wall temperatures associated with a respective plurality of locations about a periphery of the wall of the steam conduit, a density measurement associated with the steam flow, a stress within the wall of the steam conduit, and a strain in the wall of the steam conduit.

The controller may be operably configured to cause the delivery of heat flux to be interrupted in response to the at least one parameter exceeding a threshold level.

In accordance with another disclosed aspect there is provided an apparatus for increasing steam quality of a steam flow being transported through a steam conduit, the steam flow being subject to losses during transport causing formation of condensate within the steam flow. The apparatus includes a heater operable to deliver a heat flux through a wall of the steam conduit, the heat flux being sufficient to cause at least a portion of the condensate to be vaporized thereby increasing the steam quality of the steam flow in the steam conduit.

The steam conduit may include an inlet for receiving the steam flow and an outlet located at a remote location with respect to the inlet, the heater being disposed to deliver the heat flux along a portion of the steam conduit proximate the outlet.

The heater may be configured to deliver a sufficiently uniform heat flux to reduce temperature gradients within the wall of the steam conduit below a temperature gradient threshold.

The heater may be configured to deliver a heat flux having sufficient uniformity to prevent local temperature increases in the wall of the steam conduit exceeding a wall temperature threshold associated with safe transport of steam through the steam conduit.

The heater may be configured to generate heat at a plurality of locations disposed about a periphery of the steam conduit.

The heater may be configured to generate heat at a plurality of locations spaced outwardly from the wall of the steam conduit.

The heater may include a heat radiator operable to couple the heat flux into the wall of the steam conduit by thermal radiation.

The heater may include thermal insulation for reducing heat losses to an environment surrounding the steam conduit.

The heater may include a housing enclosing the heater and the thermal insulation.

The housing may be configured to permit installation on the steam conduit while the steam conduit is transporting a steam flow.

The heater may include an electrical heater having a plurality of heating elements disposed about a periphery of the steam conduit.

The heater may include an electrical heater having a plurality of heating elements each extending along at least a portion the steam conduit.

The apparatus may include a controller operably configured to monitor at least one parameter associated with transport of the steam flow along the steam conduit and to control the heater for delivering the heat flux in response to the at least one parameter.

The at least one parameter may include at least one of an electrical power level associated with delivering the heat flux, a steam flow temperature within the steam conduit, a wall temperature of the steam conduit, a plurality of wall temperatures associated with a respective plurality of locations about a periphery of the wall of the steam conduit, a density measurement associated with the steam flow, a stress within the wall of the steam conduit, and a strain in the wall of the steam conduit.

The controller may be operably configured to cause the delivery of heat flux to be interrupted in response to the at least one parameter exceeding a threshold level.

Other aspects and features of the present invention will become apparent to those ordinarily skilled in the art upon review of the following description of specific embodiments of the invention in conjunction with the accompanying figures.

### BRIEF DESCRIPTION OF THE DRAWINGS

In drawings which illustrate embodiments of the invention,

FIG. 1 is a schematic view of a system for delivering steam to a wellhead in accordance with an embodiment of the invention;

FIG. 2 is a cross sectional view of a steam conduit taken along a line 2-2 in FIG. 1;

FIG. 3 is a cross sectional view of an embodiment for heating the steam conduit shown in FIG. 1;

FIG. 4A is a cross sectional view of another embodiment for heating the steam conduit shown in FIG. 1;

FIG. 4B is a side view of the embodiment for heating the steam conduit shown in FIG. 4A;

FIG. 5A is a cross sectional view of an alternative embodiment for housing the heaters shown in FIG. 2 or FIG. 3;

FIG. 5B is a side view of the housing shown in FIG. 5A; and

FIG. 6 is a flowchart of a process for delivering the steam flow to a wellhead shown in FIG. 1.

### DETAILED DESCRIPTION

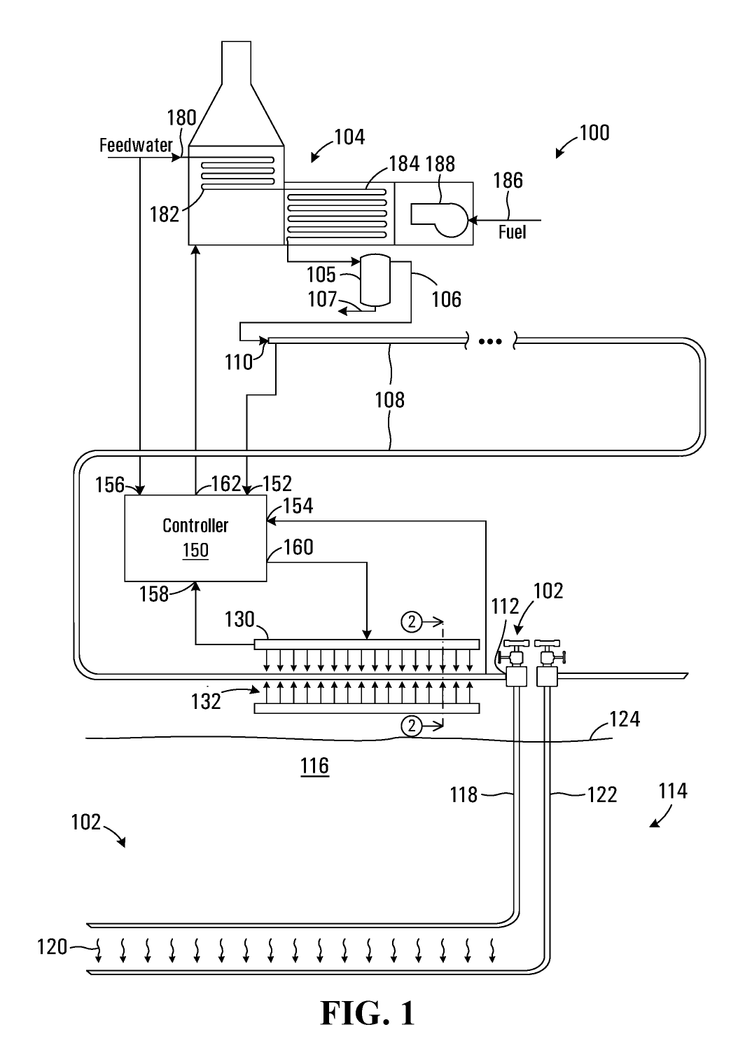

Referring to FIG. 1, a system for delivering steam to a wellhead 102 according to a first embodiment of the invention is shown generally at 100. The system 100 includes a steam generator 104 for generating steam. The system 100 also includes a steam separator 105. The steam separator 105 receives steam generated by the steam generator 104 having some liquid content and produces a substantially dry steam flow 106. Liquid removed from the generated steam by the steam separator 105 is drained through a line 107. The system 100 also includes a steam conduit 108 having an inlet 110 for receiving the steam flow and an outlet 112 proximate the wellhead 102. The steam conduit 108 is operable to transport the steam flow 106 from the inlet 110 to the outlet 112 for delivering the steam flow to the wellhead 102.

In the steam generator embodiment shown at 104 in FIG. 1, a feedwater stream 180 is received at an inlet and passes through a first heating loop 182 and a second heating loop 184. The steam generator 104 receives a fuel feed 186 for firing a burner 188 to generate heat. The heat produced by the burner 188 heats both the second loop 184 and the first loop 182. The first heating loop 182 is for preheating the feedwater while the second heating loop 184 produces steam at an outlet of the second heating loop. The steam generator 104 is generally known as a once-through steam generator (OTSG). Various other steam generation embodiments may be used to generate steam in place of the OTSG steam generator 104 shown in FIG. 1.

In the embodiment shown the wellhead 102 is associated with a steam-assisted in situ hydrocarbon recovery operation 114, in which steam is injected into a hydrocarbon-bearing formation 116 via a first wellbore 118 and the steam forms a steam chamber about the first wellbore. The viscosity of hydrocarbon products 120 within the steam chamber are lowered by the heating effect of the steam facilitating flow under forces of gravity within the formation 116 to a second wellbore 122. Hydrocarbon products are collected by the second wellbore 122 and are produced to a surface 124 of the formation 116. In other recovery operations a single wellbore may be used for both steam delivery and for hydrocarbon production to the surface.

In other embodiments, the steam flow delivered to the wellhead 102 may be used in other hydrocarbon recovery operations, such as a cyclic steam stimulation process or a steam flooding process, for example.

It is common in hydrocarbon recovery operations for the inlet 110 to be located at a remote location with respect to the wellhead 102. The inlet 110 and outlet 112 of the steam conduit 108 may separated by a distance that could range between a few hundred meters to several kilometers. Thermal losses and pressure losses along the steam conduit 108 will cause the formation of some liquid condensate within the steam flow, thereby reducing the steam quality at the outlet 112. Steam quality is generally expressed as a percentage of the mass of the stream that is in the vapor state, with dry steam having a quality of 100%. In one embodiment the 104 may be configured to generate steam having a quality of between about 80% to 95% and the steam separator 105 may dry the steam such that the steam flow 106 is substantially dry and has a steam quality of at or above 98%. In general, it is usually considered desirable to have some liquid entrained in the substantially dry steam flow 106, since the liquid provides a sweeping function for taking up impurities that may deposit on walls of the steam conduit 108. Even for steam flow 106 having a steam quality of close to 100% at the inlet 110, transport along the steam conduit 108 may result in a reduction in steam quality at the outlet 112 of several percent or more.

As the steam condenses in the steam chamber in an in situ hydrocarbon recovery operation, latent heat is given off during the phase change, which is additional to the sensible heat due to the temperature of the delivered steam flow. In situ hydrocarbon recovery operations also generally require injection of dry steam having very high steam quality, since any condensed liquid content injected into the steam chamber essentially drains to the second wellbore 122 and becomes entrained in the produced hydrocarbon products. The condensed liquid content must then be removed from the produced stream at the second wellbore 122, and thus adds to hydrocarbon recovery costs without contributing to heat delivery. It is therefore generally desirable to deliver a very high steam quality steam flow to the wellhead 102, although as disclosed above it is also generally considered desirable to have some liquid entrained in the steam flow 106, to provide a sweeping function for taking up solids and impurities that may deposit on walls of the steam conduit 108. In some embodiments the steam delivery target range may be set at or in excess of 98%.

In the embodiment shown in FIG. 1, the system 100 includes a heater 130 operable to deliver a heat flux 132 through a wall of the steam conduit 108. The heater 130 is disposed at a location along the steam conduit 108 and the heat flux 132 causes at least a portion of the liquid condensate in the steam flow 106 to be vaporized before reaching the outlet 112 of the steam conduit. The re-vaporization of the liquid condensate increases the steam quality of the steam flow 106 to a second steam quality for deliver to the wellhead 102.

In this embodiment the heater 130 is located proximate the wellhead 102 and delivers a heat flux along a portion of the steam conduit proximate the wellhead. For example the inlet 110 and the outlet 112 of the steam conduit 108 may be spaced apart by more than about 1000 meters and the heater 130 may be disposed to deliver the heat flux to a final portion of the steam conduit. As an example, the heater 130 may be disposed to deliver the heat flux to a portion of the steam conduit 108 between the outlet 112 at the wellhead 102 and a location between about 50 and about 300 meters along the steam conduit from the wellhead. In other embodiments, the steam conduit 108 may be operable to deliver steam to a plurality of wellheads and a heat flux may be delivered to portions of the steam conduit disposed to deliver steam to more than one wellhead.

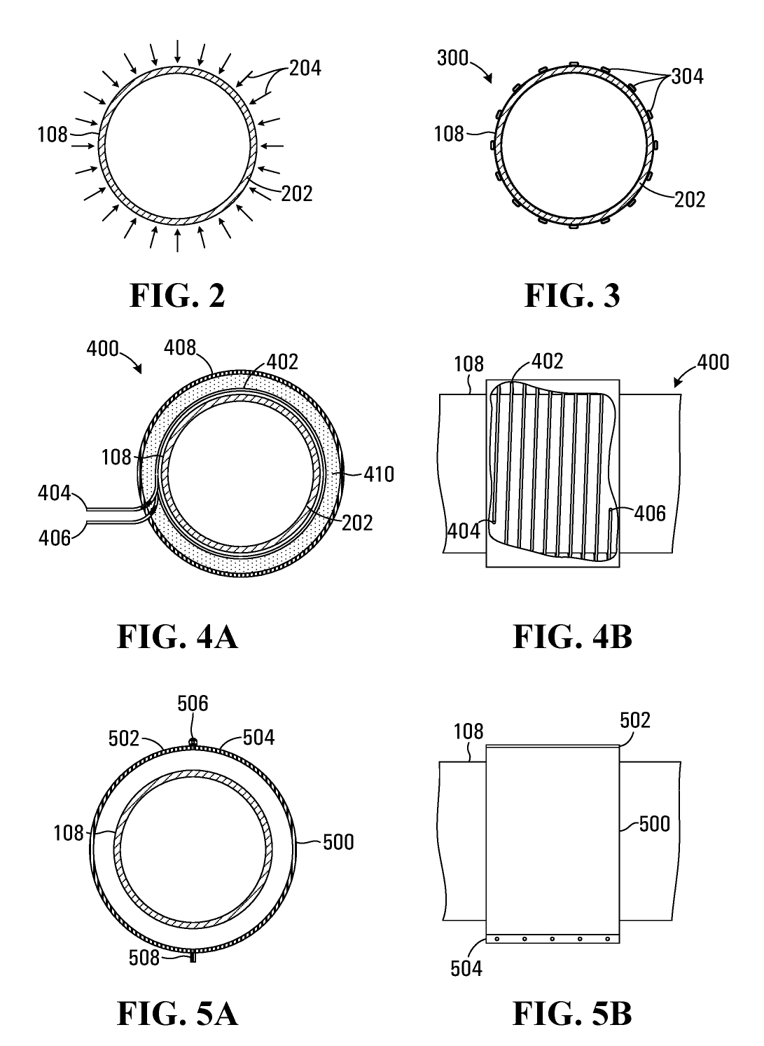

Referring to FIG. 2 the steam conduit 108 is shown in cross section in FIG. 2 and includes a wall 202. The heater 130 (shown in FIG. 1) is configured to deliver a sufficiently uniform heat flux (indicated by arrows 204) to reduce temperature gradients within the wall 202 of the steam conduit below a temperature gradient threshold. In this case the temperature gradient of concern is along the wall 202, circumferentially or along the length of the steam conduit 108, rather than between the external and internal surfaces of the wall. As an example, for a 324 millimeter diameter carbon steel steam conduit having a wall thickness of about 12 mm, a maximum temperature of about 344° C. may be used as a design temperature for the steam conduit. Under these conditions the temperature gradient threshold may be set to about 324° C. or about 20° C. lower than the maximum wall temperature. In practice, it is difficult to deliver a perfectly uniform heat flux through the wall 202 and the heater may cause hot spots that cause local temperature increases in the wall. The temperature gradient threshold may thus be adjusted to ensure that no portion of the wall 202 exceeds the maximum wall temperature associated with safe transport of steam through the steam conduit 108. The temperatures above are provided only as an example, and for other conduit materials and dimensions and/or under more or less stringent safety requirements the temperatures and temperature gradients may differ from those provided.

Referring to FIG. 3, a heater embodiment for heating the steam conduit 108 is shown generally at 300. The steam conduit 108 is shown in cross section and a plurality of electrical trace heating elements 304 are arranged about the wall 202 of the steam conduit 108. The electrical trace heating elements 304 run along a length of the conduit 108 and provide the heat flux for heating the wall 202. Conventional trace heating elements generally include an electrically insulated pair of conductors that operate as a power bus and include resistive heating wire electrically connected to and wound about the power bus. Additional insulating and grounding layers generally enclose the resistive heating wire and provide for conductive transfer of heat to the wall of the conduit being heated. The trace heating elements 304 are connected to a power supply (not shown) and the number of heating elements and current carrying capacity of each is selected to provide a required temperature increase at the wall 202. In this embodiment the heat flux is thus generated by converting electrical energy into thermal energy at a plurality of locations disposed about the periphery of the steam conduit 108.

In another embodiment, band heaters may be substituted for the trace heating elements 304. Band heaters include a heating element carried in a strap that encloses and clamps around the conduit. In common configurations, the band is a few inches wide and several band heaters may be placed adjacent to each other to provide the necessary heat flux.

Referring to FIG. 4A and FIG. 4B, another heater embodiment for heating the steam conduit 108 is shown generally at 400. The steam conduit 108 is shown in cross section in FIG. 4A and in side view in FIG. 4B. An inductor coil 402 extends about the steam conduit 108 and includes terminals 404 and 406 for receiving a high frequency alternating electrical current from a power supply such as a high frequency inverter circuit. The alternating electrical current induces eddy currents within the wall 202 of the steam conduit 108 leading to Joule heating of the wall 202. In practice, a plurality of inductor coils such as the coil 402 would be disposed along the wall 202 of the steam conduit 108, each coil receiving a high frequency alternating current for generating the heat flux.

In the embodiment shown in FIG. 4A and FIG. 4B, the inductor coil 402 is enclosed within a housing 408 and a space between the housing and the inductor coil is filled with a thermally insulating material 410 for reducing heat loss to an environment surrounding the steam conduit 108. In one embodiment, the thermally insulating material 410 may be a mineral wool insulator.

Referring to FIG. 5A and FIG. 5B, in an alternative embodiment, the heater 130 may be enclosed in a housing 500 that is configured to permit installation on the steam conduit 108 while the steam conduit is transporting a steam flow. The housing 500 includes a first portion 502 and a second portion 504, which are hinged at a hinge joint 506. The housing 500 also include a closure 508 and the portions 502 and 504 may be opened to permit the housing 500 to be lowered over the steam conduit 108 while a steam flow is being transported through the steam conduit. The closure 508 may include flanges that accept clamps or bolts for securing the housing 500 in place on the steam conduit 108.

Referring back to FIG. 1, the system 100 further includes a controller 150 for monitoring and/or controlling transport of the steam flow 106 along the steam conduit 108. The controller 150 includes a plurality of inputs, including an input 152 for receiving parameter values associated with the steam flow 106 at the inlet 110, an input 154 for receiving parameter values associated with the steam flow at the outlet 112, and an input 156 for receiving parameter values associated with the feedwater supplied to the steam generator 104. In general the parameter values are generated by sensors disposed to measure various properties of the steam flow 106. In one embodiment the parameter values associated with the steam flow 106 at the inlet and outlet 110 and 112 and may include a pressure P associated with the steam flow 106, a temperature T of the steam flow, and a pressure difference ΔP across an inline orifice plate (not shown). Similarly the parameter values associated with the feedwater received at the input 156 may include a pressure P associated with the feedwater supply, a temperature T of the feedwater, and a pressure difference ΔP across an inline orifice plate (not shown). The parameter values associated with the feedwater supply may be used to calculate a density and a mass flow rate of the feedwater, and the parameter values associated with the steam flow 106 at the inlet and outlet 110 and 112 may be used to estimate the steam quality of the steam flow 106 at the inlet and outlet in accordance with the process disclosed in US patent application US 2013/0161009A1 published on Jun. 27, 2013 and incorporated herein by reference in its entirety.

The controller 150 also includes an input 158 for receiving parameter values associated with delivering the heat flux, such as an electrical power level delivered to the heater, one or more wall temperatures at locations about a periphery of the wall 202 of the steam conduit 108, a stress within the wall, and a strain in the wall of the steam conduit.

The controller 150 further includes a signal output 160 for controlling a power level supplied to the heater 130. For example, in the inductor coil heating embodiment 400 shown in FIG. 4A and FIG. 4B, the output 160 may produce an inverter control signal for controlling the inverter operable to generate the high frequency current drive for the inductor coil 402. The controller 150 also includes an output 162 for producing a signal for facilitating control of the steam generator 104. In one embodiment the signal at the output 162 is used to provide information to an operator of the steam generator 104 and the operator may make operating adjustments to the steam generator, for example controlling the fuel feed 186 to generate more or less heat for increasing or reducing the steam quality generated by the steam generator 104. In other embodiments, the signal produced at the output 162 may be used for closed loop control of the steam generator 104. The controller 150 may be implemented using any suitable industrial process controller, and may include a microprocessor or microcontroller circuit having interfaces for receiving the various inputs and generating the signal outputs. The controller may operate autonomously or may provide information to an operator and receive operator input for controlling the steam generation by the steam generator 104 and the steam flow 106 through the steam conduit 108. Other parameters such as a bulk density associated with the steam flow may also be received the the controller 150 and may be used in controlling the steam quality.

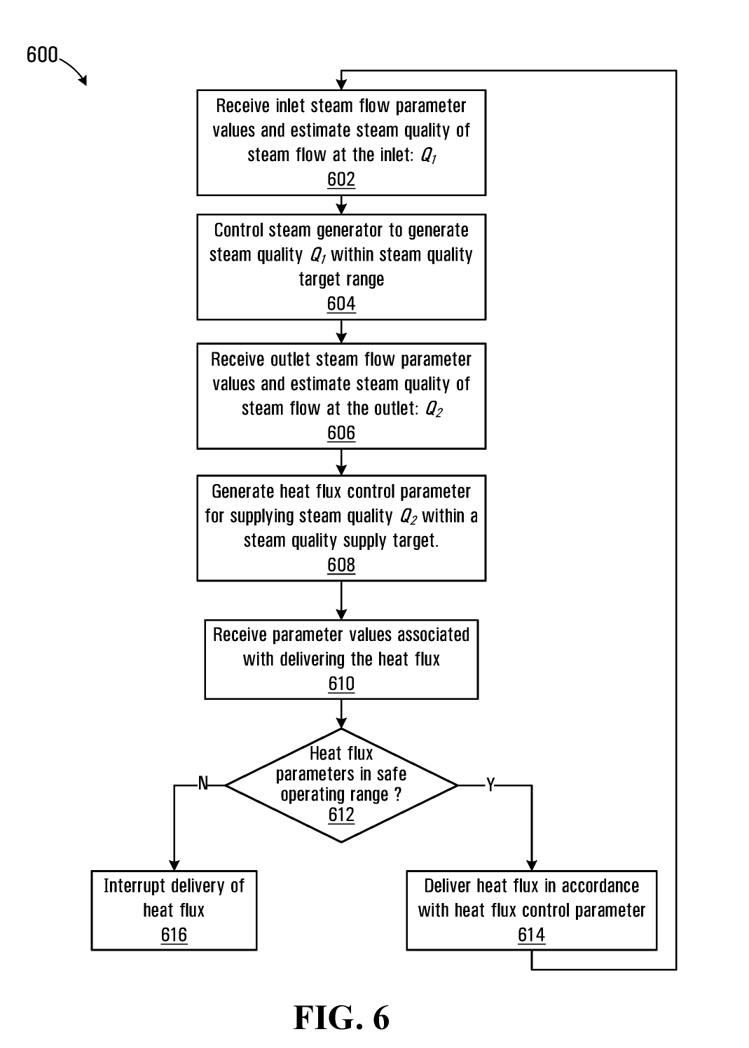

In the embodiment shown in FIG. 1, the controller 150 monitors at least one parameter associated with the steam flow and controls the heater 130 for delivering the heat flux in response to the at least one parameter. Referring to FIG. 6, a process implemented by the controller 150 for delivering the steam flow to the wellhead 102 is shown as a process flowchart 600. The process 600 commences at block 602, in which the controller 150 receives the steam flow and feedwater parameter values at the inputs 152 and 156 and estimates the first steam quality Q₁ of the steam flow 106 at the inlet 110.

At block 604 the controller 150 produces control signals for controlling the steam generator to generate steam having steam quality Q₁ within a steam delivery target range. In one embodiment the controller 150 generates signals for controlling the burner 188 to generate more or less heat based on the estimated steam quality Q₁ with respect to the steam delivery target range.

At block 606 the controller 150 receives the steam flow and feedwater parameter values at the inputs 154 and 156 and estimates the second steam quality Q₂ for the steam flow 106 at the outlet 112. At block 608, the controller 150 generates a heat flux control parameter for delivering steam quality Q₂ at the outlet 112 within a target steam quality delivery range. At block 610, the controller 150 receives the parameter values associated with delivering the heat flux 132 at the input 158 and at block 612 the controller evaluates the parameters to determine whether the steam conduit 108 is being operated within a safe operating range associated with safe transport of steam through the steam conduit. The safe operating range may be assessed by the controller 150 based on a plurality of inputs. Such inputs may include the temperature of the wall 202 remaining within the threshold wall temperature, the pressure within the steam conduit 108 being below a threshold steam flow pressure, and/or the stress or strain in the wall of the steam conduit being within safe operating limits. At block 612, if the controller 150 determines that the parameters associated with delivery of the heat flux 132 are within the various thresholds the delivery of heat flux proceeds at block 614 in accordance with the heat flux control parameter generated at block 608. If at block 612 the controller 150 determines that the parameters associated with delivery of the heat flux 132 are outside of any of the various limits and/or threshold levels, at block 616 the delivery of heat flux is interrupted by the controller 150 and a warning for alerting the operator of the steam delivery system 100 may also be generated.

In one embodiment, the steam generation target range and the steam delivery target range associated with the first and second steam qualities may be selected to optimize an overall economic efficiency associated with generation of the steam flow and the recovery of hydrocarbons the hydrocarbon recovery operation. Such selection of the target range may be based on a number of different inputs, such as an effect of steam quality supplied to the first wellbore 118 on the production of hydrocarbons from the hydrocarbon recovery operation 114, a market price for the recovered hydrocarbon products, costs associated with the fuel feed 186, and energy costs associated with generating the heat flux, for example.

The above embodiments of the steam delivery system 100 provide for delivery of high quality steam flow at a wellhead 102 located some distance away from the steam generator 104. The heater 130 provides a heat flux that compensates for losses in the transport of the 106 along the steam conduit 108, boosting the steam quality to a sufficiently high quality level for efficient production of hydrocarbons from the hydrocarbon recovery operation 114.

While specific embodiments of the invention have been described and illustrated, such embodiments should be considered illustrative of the invention only and not as limiting the invention as construed in accordance with the accompanying claims.

What is claimed is:

1. A process for delivering steam to a wellhead associated with a steam-assisted hydrocarbon recovery operation, the process comprising:
receiving a steam flow having a first steam quality at an inlet of a steam conduit, the inlet being located at a remote location with respect to the wellhead;
transporting the steam flow along the steam conduit to an outlet at the wellhead, the steam flow being subject to losses during transport along the steam conduit causing formation of condensate within the steam flow thereby reducing the steam quality at the outlet; and
delivering a heat flux through a wall of the steam conduit, the heat flux being sufficient to cause at least a portion of the condensate to be vaporized before reaching the outlet of the steam conduit thereby increasing the steam quality to a second steam quality for delivery to the wellhead.

2. The process of claim 1 wherein delivering the heat flux comprises delivering a heat flux along a portion of the steam conduit proximate the wellhead.

3. The process of claim 2 wherein the inlet of the steam conduit and the outlet of the steam conduit are spaced apart by more than about 1000 meters and wherein delivering the heat flux along the portion of the steam conduit comprises delivering a heat flux along a portion of the steam conduit extending between the outlet at the wellhead and a location between about 50 and about 300 meters along the steam conduit from the wellhead.

4. The process of claim 1 wherein delivering the heat flux comprises delivering a sufficiently uniform heat flux to reduce temperature gradients within the wall of the steam conduit below a temperature gradient threshold.

5. The process of claim 4 wherein delivering the sufficiently uniform heat flux comprises delivering a heat flux having sufficient uniformity to prevent local temperature increases in the wall of the steam conduit exceeding a wall temperature threshold associated with safe transport of steam through the steam conduit.

6. The process of claim 1 wherein receiving the steam flow comprises generating the steam flow in a steam generator and further comprising:
selecting a steam generation target range for the first steam quality;
controlling the steam generator to provide a steam flow having a steam quality within the steam generation target range; and
controlling the delivery of heat flux to increase the second steam quality to within a steam delivery target range.

7. The process of claim 6, wherein at least one of the steam generation target range and the steam delivery target range is selected to optimize an overall economic efficiency associated with generation of the steam flow and the recovery of hydrocarbons in the hydrocarbon recovery operation.

8. The process of claim 1 wherein the steam conduit is operable to delivery steam to a plurality of wellheads and wherein delivering the heat flux comprises delivering a heat flux to portions of steam conduit disposed to deliver steam to at least two of the plurality of wellheads.

9. The process of claim 1 wherein delivering the heat flux comprises generating heat at a plurality of locations disposed about a periphery of the steam conduit.

10. The process of claim 9 wherein generating heat at the plurality of locations disposed about the periphery of the steam conduit comprises generating heat at a plurality of locations spaced outwardly from the wall of the steam conduit.

11. The process of claim 10 wherein generating heat comprises generating heat to cause at least a portion of the generated heat to be coupled into the wall by thermal radiation of the steam conduit.

12. The process of claim 9 further comprising providing thermal insulation between the plurality of locations disposed about the periphery of the steam conduit and an environment surrounding the steam conduit.

13. The process of claim 12 further comprising enclosing the heat generating locations and the thermal insulation within a housing.

14. The process of claim 13 wherein the housing is configured to permit installation on the steam conduit while the steam conduit is transporting a steam flow.

15. The process of claim 1 wherein delivering the heat flux comprises generating the heat flux by converting electrical energy into thermal energy at a plurality of heating elements disposed about a periphery of the steam conduit.

16. The process of claim 1 wherein delivering the heat flux comprises generating the heat flux by converting electrical energy into thermal energy at a plurality of heating elements each extending along at least a portion the steam conduit disposed to deliver steam flow to the wellhead.

17. The process of claim 1 further comprising monitoring at least one parameter associated with transporting the steam flow along the steam conduit and controlling the delivery of heat flux in response to the at least one parameter.

18. The process of claim 17 wherein the at least one parameter comprises at least one of:
an electrical power level associated with delivering the heat flux;
a steam flow temperature within the steam conduit;
a wall temperature of the steam conduit;
a plurality of wall temperatures associated with a respective plurality of locations about a periphery of the wall of the steam conduit;
a density measurement associated with the steam flow;
a stress within the wall of the steam conduit; and
a strain in the wall of the steam conduit.

19. The process of claim 17 wherein controlling the delivery of heat flux comprises interrupting the delivery of heat flux in response to the at least one parameter exceeding a threshold level.

20. A system for delivering steam to a wellhead associated with a steam-assisted hydrocarbon recovery operation, the system comprising:
a steam generator for generating a steam flow having a first steam quality;
a steam conduit having an inlet for receiving the steam flow and an outlet proximate the wellhead, the inlet being located at a remote location with respect to the wellhead, the steam conduit being operable to transport the steam flow to the outlet, the steam flow being subject to losses during transport along the steam conduit causing formation of condensate within the steam flow thereby reducing the steam quality at the outlet; and
a heater operable to deliver a heat flux through a wall of the steam conduit, the heat flux being sufficient to cause at least a portion of the condensate to be vaporized before reaching the outlet of the steam conduit thereby increasing the steam quality to a second steam quality for delivery to the wellhead.

21. The system of claim 20 wherein the heater is disposed to deliver the heat flux along a portion of the steam conduit proximate the wellhead.

22. The system of claim 21 wherein the inlet of the steam conduit and the outlet of the steam conduit are spaced apart by more than about 1000 meters and wherein the heater is disposed to deliver the heat flux along the portion of the steam conduit between the outlet at the wellhead and a location between about 50 and about 300 meters along the steam conduit from the wellhead.

23. The system of claim 20 wherein the heater is configured to deliver a sufficiently uniform heat flux to reduce temperature gradients within the wall of the steam conduit below a temperature gradient threshold.

24. The system of claim 23 wherein the heater is configured to deliver a heat flux having sufficient uniformity to prevent local temperature increases in the wall of the steam conduit exceeding a wall temperature threshold associated with safe transport of steam through the steam conduit.

25. The system of claim 20, further comprising a controller operable to:
control the steam generator to generate a steam flow having a first steam quality within a selected steam generation target range; and
control the heater to deliver the heat flux to increase the second steam quality to within a steam delivery target range.

26. The system of claim 25 wherein at least one of the steam generation target range and the steam delivery target range is selected to optimize an overall economic efficiency associated with generation of the steam flow and the recovery of hydrocarbons in the hydrocarbon recovery operation.

27. The system of claim 20 wherein the steam conduit is operable to deliver steam to a plurality of wellheads and wherein the heater comprises a plurality of heaters, each heater being disposed to deliver a heat flux to a portion of the steam conduit disposed to deliver steam to each respective wellhead in the plurality of wellheads.

28. The system of claim 20 wherein the heater is configured to generate heat at a plurality of locations disposed about a periphery of the steam conduit.

29. The system of claim 28 wherein the heater is configured to generate heat at a plurality of locations spaced outwardly from the wall of the steam conduit.

30. The system of claim 29 wherein the heater comprises a heat radiator operable to couple the heat flux into the wall of the steam conduit by thermal radiation.

31. The system of claim 28 wherein the heater comprises thermal insulation for reducing heat losses to an environment surrounding the steam conduit.

32. The system of claim 31 wherein the heater comprises a housing enclosing the heater and the thermal insulation.

33. The system of claim 32 wherein the housing is configured to permit installation on the steam conduit while the steam conduit is transporting a steam flow.

34. The system of claim 20 wherein the heater comprises an electrical heater having a plurality of heating elements disposed about a periphery of the steam conduit.

35. The system of claim 20 wherein the heater comprises an electrical heater having a plurality of heating elements each extending along at least a portion the steam conduit disposed to deliver steam to the wellhead.

36. The system of claim 20 further comprising a controller operably configured to monitor at least one parameter associated with transport of the steam flow along the steam conduit and to control the heater for delivering the heat flux in response to the at least one parameter.

37. The system of claim 36 wherein the at least one parameter comprises at least one of:
an electrical power level associated with delivering the heat flux;
a steam flow temperature within the steam conduit;
a wall temperature of the steam conduit;
a plurality of wall temperatures associated with a respective plurality of locations about a periphery of the wall of the steam conduit;
a density measurement associated with the steam flow;
a stress within the wall of the steam conduit; and
a strain in the wall of the steam conduit.

38. The system of claim 36 wherein the controller is operably configured to cause the delivery of heat flux to be interrupted in response to the at least one parameter exceeding a threshold level.

39. An apparatus for increasing steam quality of a steam flow being transported through a steam conduit, the steam flow being subject to losses during transport causing formation of condensate within the steam flow, the apparatus comprising:
a heater operable to deliver a heat flux through a wall of the steam conduit, the heat flux being sufficient to cause at least a portion of the condensate to be vaporized thereby increasing the steam quality of the steam flow in the steam conduit.

40. The apparatus of claim 39 wherein the steam conduit comprises an inlet for receiving the steam flow and an outlet located at a remote location with respect to the inlet, the heater being disposed to deliver the heat flux along a portion of the steam conduit proximate the outlet.

41. The apparatus of claim 39 wherein the heater is configured to deliver a sufficiently uniform heat flux to reduce temperature gradients within the wall of the steam conduit below a temperature gradient threshold.

42. The apparatus of claim 41 wherein the heater is configured to deliver a heat flux having sufficient uniformity to prevent local temperature increases in the wall of the steam conduit exceeding a wall temperature threshold associated with safe transport of steam through the steam conduit.

43. The apparatus of claim 39 wherein the heater is configured to generate heat at a plurality of locations disposed about a periphery of the steam conduit.

44. The apparatus of claim 43 wherein the heater is configured to generate heat at a plurality of locations spaced outwardly from the wall of the steam conduit.

45. The apparatus of claim 44 wherein the heater comprises a heat radiator operable to couple the heat flux into the wall of the steam conduit by thermal radiation.

46. The apparatus of claim 43 wherein the heater comprises thermal insulation for reducing heat losses to an environment surrounding the steam conduit.

47. The apparatus of claim 46 wherein the heater comprises a housing enclosing the heater and the thermal insulation.

48. The apparatus of claim 47 wherein the housing is configured to permit installation on the steam conduit while the steam conduit is transporting a steam flow.

49. The apparatus of claim 39 wherein the heater comprises an electrical heater having a plurality of heating elements disposed about a periphery of the steam conduit.

50. The apparatus of claim 39 wherein the heater comprises an electrical heater having a plurality of heating elements each extending along at least a portion the steam conduit.

51. The apparatus of claim 39 further comprising a controller operably configured to monitor at least one parameter associated with transport of the steam flow along the steam conduit and to control the heater for delivering the heat flux in response to the at least one parameter.

52. The apparatus of claim 51 wherein the at least one parameter comprises at least one of:
an electrical power level associated with delivering the heat flux;
a steam flow temperature within the steam conduit;
a wall temperature of the steam conduit;
a plurality of wall temperatures associated with a respective plurality of locations about a periphery of the wall of the steam conduit;
a density measurement associated with the steam flow;
a stress within the wall of the steam conduit; and
a strain in the wall of the steam conduit.

53. The apparatus of claim 51 wherein the controller is operably configured to cause the delivery of heat flux to be interrupted in response to the at least one parameter exceeding a threshold level.
